(19) United States
(12) Patent Application Publication
(10) Pub. No.: US 2008/0245206 A1
(43) Pub. Date: Oct. 9, 2008

(54) Machine-Type Device For Raising Machine Punches of the Type Using Adiabatic Energy Change

(75) Inventors: Raymond Michon, Ecotay L'Olme (FR); Alain Chapuis, La Fouillouse (FR)

Correspondence Address: HESLIN ROTHENBERG FARLEY & MESITI PC, 5 COLUMBIA CIRCLE, ALBANY, NY, 12203, US

(73) Assignee: adiapress, Saint Etienne (FR)

(21) Appl. No.: 12/065,000

(22) PCT Filed: Aug. 4, 2006
(86) PCT No.: PCT/FR2006/050789

§ 371 Date: Feb. 27, 2008

(30) Foreign Application Priority Data
Aug. 31, 2005 (FR) 0552631

(51) Int. Cl. B26F 1/14

(52) U.S. Cl. 83/687

(57) ABSTRACT

In a machine using adiabatic energy change and including a worktable, a punch guiding body, a punch and punch lifting cylinders, the worktable and the guiding body are configured to enable sets of lifting push elements or rods to be positioned and moved. The push elements are arranged in aligned pairs and urged by cylinders provided beneath the worktable of the machine; an upper push rod sliding in the guiding body being adapted to co-operate with the punch to be lifted during certain operating phases.

The invention relates to the technical field of machines, machine tools using the conversion of adiabatic energy.

Machines have been developed by the applicant with, in particular, a method and device for damping energy which was the subject matter of patent FR 2.859.935.

Various researches have been conducted by the applicant, in particular on controlling the damping of the adiabatic energy, which have culminated in solutions for which parallel patent applications are in progress.

In order to optimize the operation of this type of machine, the applicant has also addressed the problem of tool replacement.

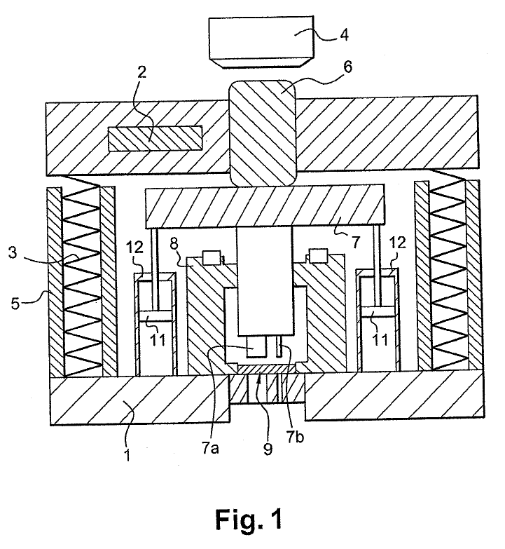

For this purpose, and for a proper understanding of the invention, FIG. 1 illustrates the operating diagram of the machine in the area of adiabatic cutting. The principle is that the punch enters the steel plate at high speed. Upon the impact of the punch on the plate, the part receives highly localized mechanical energy. This energy does not have the time to spread and create an instantaneous temperature rise. The ejection of the cutout portion is caused by the viscosity of the material combined with the force applied by the punch. This method is implemented with a machine successively comprising a work table (1), a beam (2), located in the upper horizontal plane, and bearing on means (3) for damping the energy transmitted by the pressing means (4) of the ram type. The damping means (3) are guided and maintained by vertical receiving blocks (5). The beam has a cavity for guiding a vertical pusher (6) thrusting against a punch (7) itself guided by a punch support body (8). The end of the punch is arranged with one or more tools (7a-7b) for perforating the plate to be cut (9), which advances step by step (perpendicularly to the plane of the drawing). Means (10), placed between the punch support body (8) and the machine work table, control the positioning and advance of the plate, but thereby via openings, allow the removal of the cutout parts. This punch is raised vertically by sets of cylinders (1) which actuate the various positions of the punch according to the punching steps. Thus, in this application, the punch raising cylinders are located on the machine work table and clutter its environment.

In practice, this has a number of drawbacks:

the area lost by the presence of the cylinders and their support means on the machine work table limits the size of the tools, which cannot be mounted due to the available space;

the cylinders hinder access for tool assembly and disassembly, and therefore decrease the productive time of the machine;

the hydraulic wiring and position sensors of the cylinders are located in the work area of the machine.

These drawbacks have led the applicant to reflect on a novel design of the punch lifting device which serves to overcome these limitations, to liberate the zone surrounding the tools and the machine work table, and, on the whole, serves to enhance the productivity of the machine.

According to a first feature, the punch raising device for machine of the type using the conversion of adiabatic energy, the machine being of the type including a work table, a punch support body, a punch and punch lifting cylinders, is characterized in that the work table and the punch guide block are arranged to constitute means for positioning and moving pairs of raising pushers placed in aligned pairs and actuated by cylinders placed under the work table of the machine, the upper pusher sliding in the guide body being suitable for cooperating with the punch to lift it according to certain operating phases.

These features and others will appear clearly from the rest of the description.

To define the subject matter of the invention illustrated in a non-limiting manner in the figures of the drawings:

FIG. 1 is a schematic view of the operating principle of a machine of the prior art from which the invention has been developed;

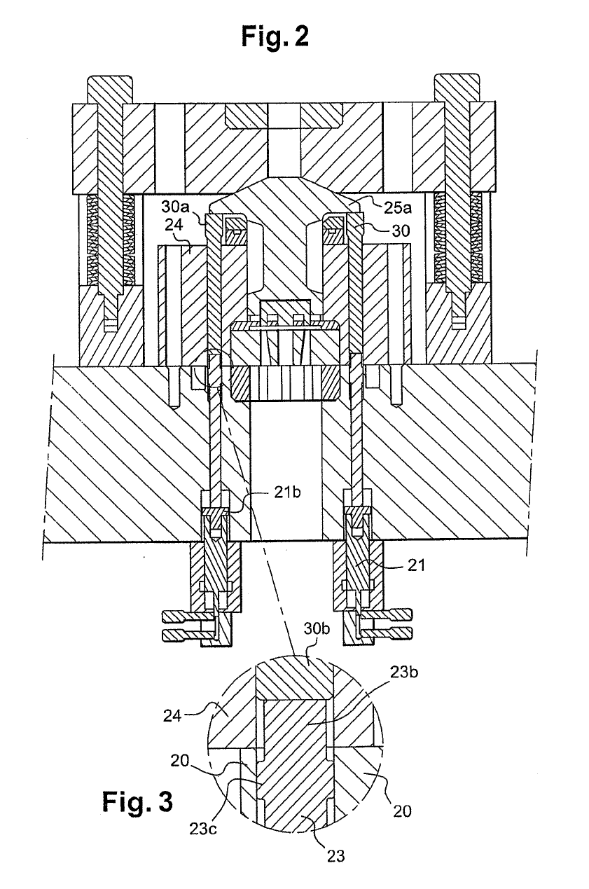

FIG. 2 is a partial view, the punch having been raised, the plate to be cut advanced, and the punch lowered on the said plate;

FIG. 3 is a large scale partial view of the circled portion in FIG. 2;

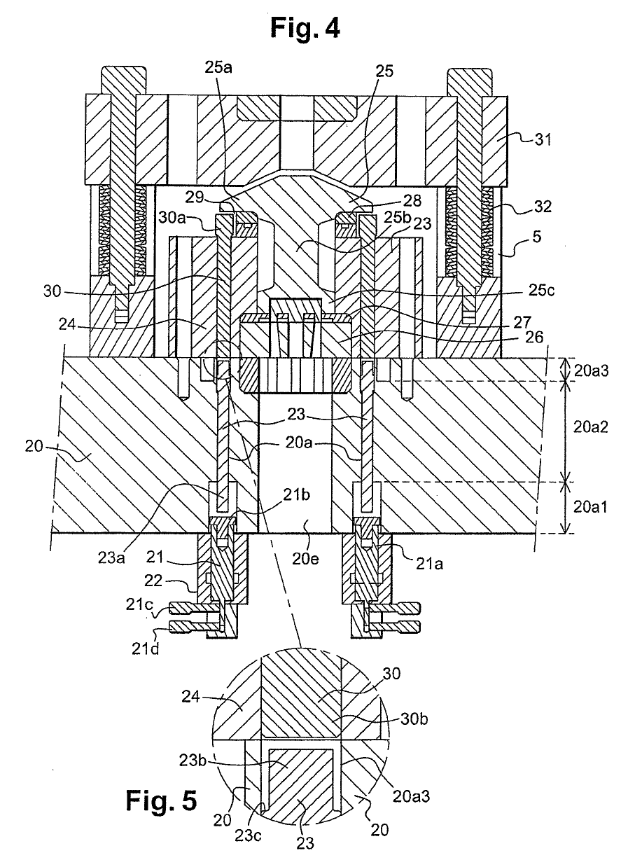

FIG. 4 is a large scale partial view of the punch raising device according to the invention. In this figure, the punch is not yet lowered to perform the cutting or stamping operation for which it is intended;

FIG. 5 is a large scale view of the circled part in FIG. 4.

To depict the subject matter of the invention more concretely, it is now described in a non-limiting manner as illustrated in the figures of the drawings.

The originality of the invention relative to the punch raising device for machines resides in the elimination of the cylinders on the work table of the machine to liberate the access to the tools for the operator during tool replacements. This is achieved by using the work table and the punch guide block as means for allowing the positioning and limited vertical movement of pairs of raising pushers placed in aligned pairs and actuated by cylinders placed under the machine work table.

The work table (20) has vertical cavities (20a) from its underside and along its whole height defining three specific zones (20a1-20a2-20a3), that is:

the zone (20a1) defines a recess for the passage of the rod (21a) of a cylinder (21) whereof the end receives a bearing and thrust base (21b). The body (22) of the cylinder is vertically fixed by any suitable means with regard to the opposite underside of the said table. The hydraulic connections (21c-21d) are provided for this purpose;

the zone (20a2), consecutive to the previous one and in its vertical prolongation, is established over a long length and allowing the passage and guiding of a first raising pusher element (23). This pusher is prepared in the form of a cylindrical or other cross section rod. The lower end (23a) of said pusher element is facing and opposite to the support base (21b) of the cylinder (21). The upper end (23b) of the pusher element is arranged slightly set back from the upper side of the table with a peripheral shoulder (23c) having a larger cross section.

the upper zone (20a3) in the prolongation and aligned with the preceding zones, has a larger cross section than the underlying zone (20a2) for thereby allowing the controlled movement of the upper part of the pusher element (23). The connection between the zones (20a2) and (20a3) having different cross sections precisely constitutes a bearing and retaining surface (20d) forming a stop of the raising pusher element (23). Thus, with reference to FIG. 2 and the inactive loading of the cylinder (21), the raising pusher element (23) rests on the stop (21d). In this situation, the upper end of the raising pusher element is substantially set back from the upper horizontal plane of the machine work table, hence without overhang.

The number of cylinders (21) and thus the number of raising pusher elements (23) is predefined by the manufacturer. These pusher elements (23) and their receiving cavity surround the cavity (20e) for removing the cutout parts of the worked plate formed in the table of the machine.

In the upper part beyond the table of the machine, the guide body (24) of the punch (25) is located, that is, the mobile portion of the head of the machine. The punch has a head (25a) overhanging the upper part of the guide body and having a larger section than its mid portion (25b) guided in a bore (24a) of the guide body, the lower part (25c) of the punch being arranged for receiving the punching tools. This guide body (24) conventionally surrounds the receiving die (26) of the plate to be cut and also the tape guide (27) of the said plate. The head of the punch is suitable for bearing against means (28) whereof the function is described in another of the applicant's patent applications. As an alternative, the cylinder is lifted by the pusher (30) via the hammer block on which the cylinder head rests. This block is pushed by the upper end of the pushers. In this case, the head of the punch is shorter and its weight reduced. This alternative is not illustrated. Thus, the punch cooperates directly or indirectly with the pusher (30) according to the embodiments, the function being the same.

According to the invention, the guide body is arranged with a plurality of holes (29) passing through vertically, and being positioned in an axial alignment with each of the cavities formed in the work table and allowing the passage of the raising pusher elements. The holes (29) identical in number to the underlying cavities allow the positioning of a second raising pusher element (30). Each pusher element (30) has a greater length than the height of the punch guide body, so as to overhang in the upper plane, in a shouldered head configuration (30a) having a larger cross section than the built-in part in the guide body. Thus, the said head (30a) bears against the horizontal upper side of the guide body. The lower end (30b) of the said pusher element does not overhang from the lower horizontal plane of the punch guide means. The arrangement of the said pusher elements (30) is such that they are opposite and below the head (25a) of the punch.

Thus, in the configuration in FIG. 4, in an unloaded situation, the pusher elements (23 and 30) do not touch and have no common action. This serves to define pairs of raising pushers (23-30) placed in a vertical alignment. FIG. 5 clearly shows this relative position. Their number is defined by the manufacturer according to the desired applications. Known means of the machine are located around the punch and its guide body, that is, a horizontal beam (31) bearing on and guided by means (32) absorbing the adiabatic energy transmitted by the striking force of the ram (not shown).

With reference to FIGS. 2 and 3 of the drawings, after punching out the plates to be cut, the activation of the cylinders (21) causes the lifting of their rod and therefore the contacting of the support stops (21b) associated with the lower raising pusher elements (23). These are then lifted and, in their turn, contact the upper pusher elements (30) and lift them so as to cause the lifting of the punch by the contact with the punch head. However, the movement remains limited due to the contact of the punch with the base of the beam.

This application serves to easily modify the position of the punching tools, after their startup, by sideways removal of the tool block.

The solution provided by the invention is simple to implement, inexpensive, and fully meets the objective.

1. Punch raising device for machine using conversion of adiabatic energy, the machine including a work table, a punch guide body, a punch and punch lifting cylinders, wherein the work table and the punch guide body are arranged for positioning and moving pairs of raising pushers elements placed in aligned pairs and actuated by cylinders placed under the work table of the machine, an upper pusher element sliding in the guide body cooperating with the punch to lift the punch according to certain operating phases.

2. Device according to claim 1, wherein the work table has vertical cavities from an underside and along a whole height of the work table defining three specific zones:
a first zone defining a recess for passage of a rod of a cylinder wherein an end of the rod receives a bearing and thrust base,
a second zone, consecutive to the first zone and in its vertical prolongation, being established over a long length and allowing passage and guiding of a first raising pusher element,
an upper zone in prolongation and aligned with the first and second zones, having a larger cross section than the second zone for thereby allowing controlled movement of the upper part of the first raising pusher element, and wherein a connection between the second and upper zones and having different cross sections precisely constitutes a bearing and retaining surface forming a stop of the first raising pusher elements.

3. Device according to claim 2, wherein the cylinder is fixed vertically in any appropriate manner with regard to the underside of said table.

4. Device according to claim 2, wherein the first raising pusher element comprises a cylindrical or other cross section rod, with a lower end facing and opposite to the base of the cylinder,
and an upper end is arranged slightly set back with a peripheral shoulder having a larger cross section.

5. Device according to claim 4, wherein, in a situation of inactive loading of the cylinder, the raising pusher element rests on the stop,
and the upper end of the raising pusher element is substantially set back from an upper horizontal plane of the machine work table, hence without overhang.

6. Device according to claim 4, wherein the number of cylinders and thus number of raising pusher elements is predefined, and the pusher elements and receiving cavity surround a cavity for removing cutout parts of a worked plate formed in the table of the machine.

7. Device according to claim 2, n wherein the punch guide body is arranged with a plurality of holes passing through vertically, and being positioned in an axial alignment with each of the cavities formed in the work table and allowing the passage of the raising pusher elements and wherein holes identical in number to the cavities (20a) allow Propositioning of a second raising pusher element.

8. Device according to claim 7, wherein each pusher element has a greater length than a height of the punch guide body, so as to overhang in an upper plane, in a shouldered head having a larger cross section than a built-in part in the guide body, and said head bears against a horizontal upper side of the guide body, in the low position, and wherein the lower end of the each pusher element does not overhang from a lower horizontal plane of the punch guide body, and wherein arrangement of the said pusher elements is such that the pusher elements are opposite and below a head of the punch.

9. Device according to claim 1, wherein the upper pusher element is positioned under a head of a cylinder to lift the cylinder.

10. Device according to claim 1, wherein the upper pusher element is positioned under a hammer block on which a cylinder head bears for lifting said cylinder.
